(19) United States
(12) Patent Application Publication
(10) Pub. No.: US 2015/0156841 A1
(43) Pub. Date: Jun. 4, 2015

(54) ARRANGEMENT AND METHOD FOR CONTROLLING LIGHT-EMITTING DIODES IN ACCORDANCE WITH AN INPUT VOLTAGE LEVEL, BY MEANS OF BRANCH SWITCHES

(71) Applicant: ZENTRUM MIKROELEKTRONIK DRESDEN AG, Dresden (DE)

(72) Inventor: Erhard Müsch, Werne (DE)

(73) Assignee: ZENTRUM MIKROELEKTRONIK DRESDEN AG, Dresden (DE)

(21) Appl. No.: 14/411,972

(22) PCT Filed: Jul. 1, 2013
(86) PCT No.: PCT/EP2013/063809

§ 371 Date: Dec. 30, 2014

(30) Foreign Application Priority Data
Apr. 29, 2012 (EP) 13165730.6
Jul. 4, 2012 (EP) 12174995.6
Jan. 31, 2013 (DE) 10 2013 10 992.1

(51) Int. Cl. H05B 33/08

(52) U.S. Cl. CPC H05B 33/0827; H05B 33/0809

(57) ABSTRACT

An arrangement and a method for controlling light-emitting diodes divided into segments of an array are provided. The second terminals of all segments in the array are connected to a constant current source via one respective switching element per terminal, resulting in formation of a number n of stages, each of which has an n-th segment and an associated n-th switching element. When the amplitude of the input alternating voltage is at zero volts, all switching elements in all n stages are through-switched. An n-th reference voltage and an node voltage measured at the second terminal of a segment in stage n+1 are compared, and if the n-th reference voltage is less than the node voltage, the switching element of the n-th stage is blocked.

The invention relates to an arrangement for actuating light-emitting diodes, comprising an input, to which an AC input voltage can be applied, and an array of LEDs connected in series, which array is connected to the outputs of the arrangement for actuating light-emitting diodes and is divided into at least two segments, and wherein each segment of the array is connected at one end at least indirectly to a constant current source.

The invention also relates to a method for actuating light-emitting diodes, in which an array of light-emitting diodes connected in series is provided, which array is divided into segments, wherein each segment contains a plurality of light-emitting diodes and has a first connection and a second connection, and wherein the array is operated on a rectified AC input voltage (VDC).

LEDs (light-emitting diodes) are increasingly used for lighting purposes since they have a number of advantages over conventional light-emitting means such as incandescent lamps or fluorescent lamps, in particular a low energy requirement and a longer life. Owing to their semiconductor-typical current-voltage characteristic, it is expedient to operate LEDs using a constant current.

During operation of light-emitting means comprising LEDs from a lighting mains, therefore, circuitry measures need to be taken in order to produce the required constant direct current with the low voltage of typically 3 . . . 4 V per LED from a high AC voltage supply, which may have voltage values of 230 VAC, for example. These values can typically apply to so-called white LEDs and may be different for other LEDs.

In addition to the widespread use of so-called AC-to-DC converters, which usually consist of a rectifier and a switched mode power supply, a method is known in which an array of LEDs connected in series is actuated directly from the rectified AC voltage via one or more linear current sources.

This arrangement is also referred to as direct AC LED. For this purpose, advantageously the LED array can be divided into segments, which are energized individually or connected in series corresponding to the instantaneous AC voltage. The number of LEDs connected in series and therefore the forward voltage of the entire LED array is thus configured such that it corresponds to a notable proportion of the amplitude of the mains voltage, which may be in the region of 80 to 90% of the amplitude of the mains voltage, for example.

The voltage drop across the linear current source is therefore kept low, which results in a comparatively high degree of efficiency. At a relatively low instantaneous voltage, only part of the LED array, corresponding to the arrangement-side segmentation of the LEDs, is likewise actuated with a relatively low voltage drop across the associated current source. As a result, the angle of current flow is increased within a half-period, which results in more uniform light emission. Optionally, the current from the linear current source or current sources can be modulated corresponding to the instantaneous mains voltage in order to increase the power factor, i.e. to keep the harmonics content of the supply current low.

Advantages of this known method over the use of AC-to-DC converters are the smaller structural form and lower costs of the drive electronics and improved EMC (electromagnetic compatibility) of the arrangement since no quick switching edges occur.

A principle disadvantage consists in the high degree of ripple of the light emission at twice the mains frequency, which sensitive people find bothersome. Even when there is constant energization of the LEDs, the light emission is reduced when fewer segments than are arranged in the LED array are active.

If the instantaneous voltage at which the LED arrays are actuated falls below the forward voltage of the first segment of the arrays, the current becomes zero, i.e. there are two gaps in each period in which there is no energization of the LEDs. In contrast to the filament of an incandescent lamp, which has considerable thermal inertia and therefore damps the ripple of the power supplied, the light emission of an LED follows the current practically without any delay. In particular these energization gaps can result in an impression of flicker of the lighting which is found to be unpleasant.

A further disadvantage in terms of circuitry in respect of the actuation consists in that the switchover thresholds of the individual segments need to be matched to the number of LEDs per segment and the actual forward voltage.

Thus, the object of the invention consists in specifying an arrangement and method for actuating light emitting diodes whereby improved actuation of the LEDs is achieved without the efficiency and/or the harmonic content being impaired.

In addition, automatic matching of the switchover thresholds between the LED arrays to the forward voltages of the segments of the LED array is intended to be achieved.

The circuit arrangements comprising the characterizing features of claims 1 and 2 provide the advantage of more uniform energization of the LEDs in an array and improvement of the efficiency.

The present object in respect of the method is achieved by the characterizing features of claims 6 and 7.

By virtue of the measures set forth in the dependent claims, advantageous developments and improvements of the invention specified in the main claims are possible.

The invention will be explained in more detail below with reference to an exemplary embodiment. In the associated drawings:

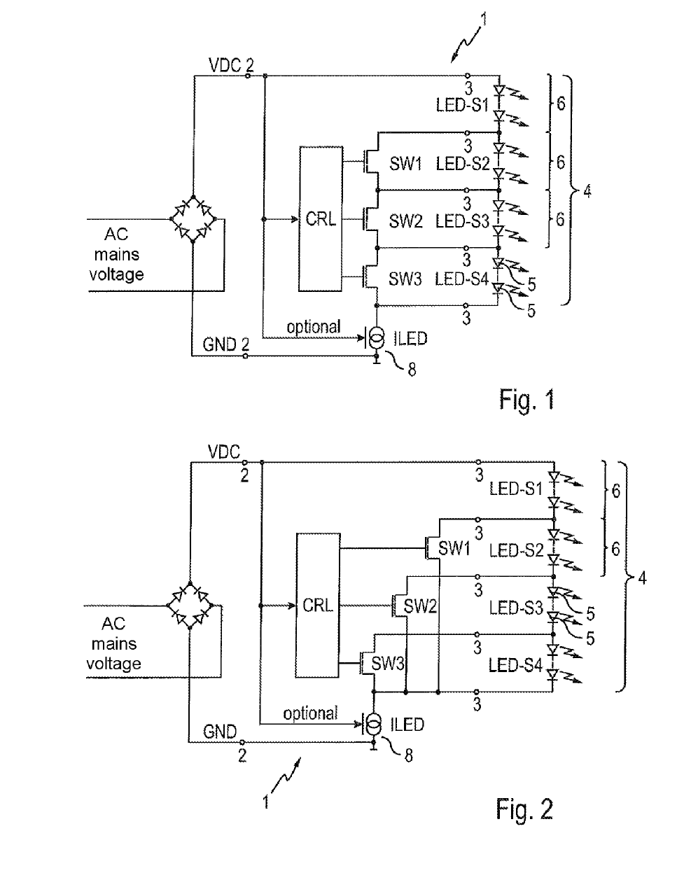

FIG. 1 shows a possible embodiment of an arrangement for actuating light-emitting diodes in accordance with the prior art in a variant as “direct AC LED drivers”,

FIG. 2 shows another possible embodiment of an arrangement for actuating light-emitting diodes in accordance with the prior art in a variant as “direct AC LED drivers”,

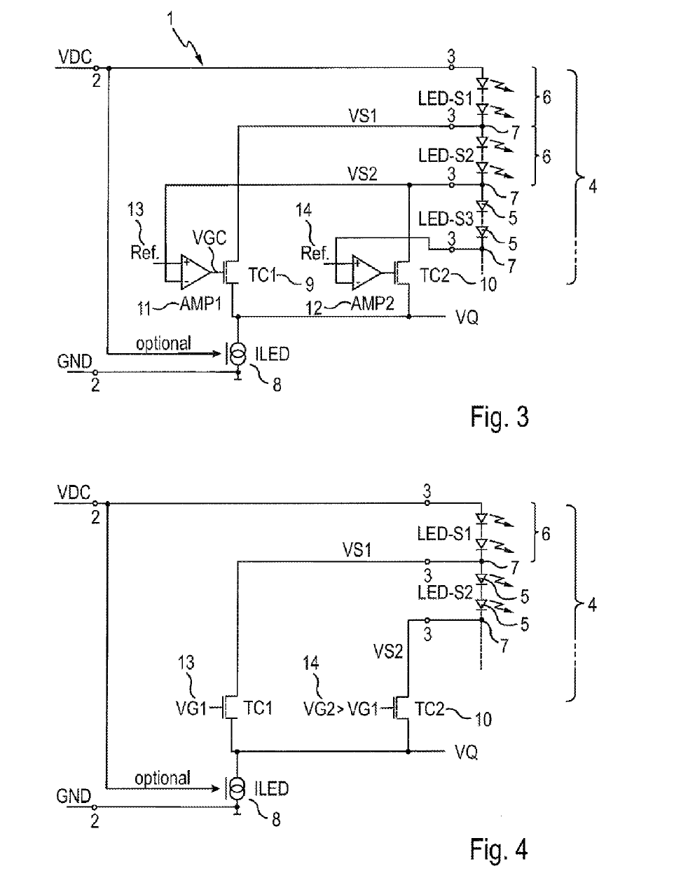

FIG. 3 shows a circuit arrangement according to the invention for actuating light-emitting diodes comprising automatic matching of the current paths to the forward voltage of the LED segments,

FIG. 4 shows a further circuit arrangement according to the invention for actuating light-emitting diodes comprising alternative automatic matching with graded gate voltages,

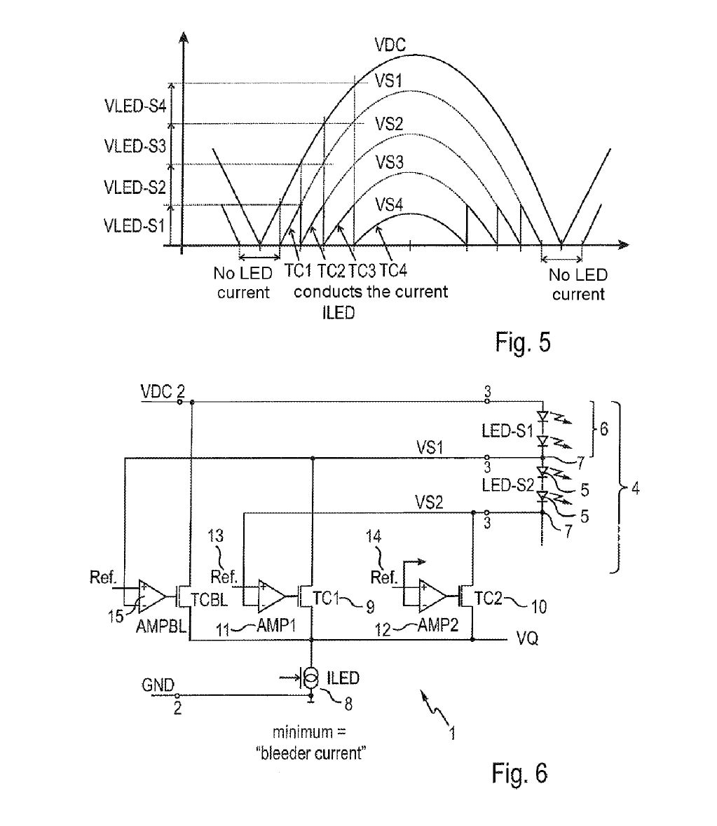

FIG. 5 shows an illustration of the voltage profiles of the rectified mains voltage and the segment voltages over a half-period, and

FIG. 6 shows a circuit arrangement for automatic control of a “bleeder current”.

FIGS. 1 and 2 show two possible embodiments of an arrangement 1 for actuating light-emitting diodes 5 in accordance with the prior art. So-called direct AC LED drivers each having four LED segments 6, which are denoted by LED-S1 to LED-S4, are illustrated. The array 4 is fed from the rectified mains voltage VDC 2, wherein a ground-side current source 8 ILED generates a constant current.

In the illustration shown in FIG. 1, the segments 6 are short-circuited by the switching elements SW1 to SW3, which can be embodied as MOSFETs, for example, corresponding to the instantaneous voltage present across the array 4.

In the configuration shown in FIG. 2, the segment taps 7 are connected to the common current source 8 ILED corresponding to the instantaneous voltage across the array 4 by means of the switching elements SW1 to SW3. A control unit CRL serves the purpose of distributing the current among the number of segments 6 appropriately for the instantaneous voltage. The current source 8 ILED can optionally be modulated corresponding to the instantaneous mains voltage VDC.

The automatic matching of the switching thresholds to the forward voltage of the segments in accordance with the invention will be described below.

FIG. 3 shows the principle using the example of three segments 6 LED-S1 to LED-S3 of an LED array 4 comprising any desired number of LEDs 5 in the respective segment 6. The number of segments 6 can be increased as desired, which is illustrated by a dash-dotted line at the connection 7 of the segment 6-LED-S3 in the figure. Likewise, the number of LEDs 5 per segment 6 is freely selectable.

The anode of the “upper” LED 5 of the segment LED-S1 6 is connected to the supply voltage VDC 2, i.e. the rectified mains voltage. Each segment 6 of the array 4 has a first and a second connection 7. In FIG. 3, the first connection of the first segment 6 is connected to the voltage VDC. The second connection 7 of the first segment 6 is connected to the first connection of the following segment 6 of the array 4. In addition, this second connection 7 is connected to a switching means 9, 10, . . . .

The entire LED array 6 is fed from a common ground-side current source 8 ILED via these switching means 9, 10 which can be switched on and off. Above the current source 8, there are so-called cascode elements TC1 and TC2 9, 10, formed by MOSFETs, bipolar transistors or IGBTs, for example, as switching means for each current path n. A series circuit of two transistors, wherein the “lower” transistor (in the case of an n-channel or NPN transistor) performs the function of control, while the “upper” transistor is used for increasing the dielectric strength and/or the output impedance, is referred to as a cascode.

n stages within the arrangement, which each comprise an n-th LED segment 6 and at least one n-th switching means 9 or 10, are formed in such a way. The first stage comprises the first segment 6 of the array 4 and the first switching means 9. In addition, another element actuating the first switching means 9 can also be included. In the example shown in FIG. 3, this is a first comparator or amplifier 11 AMP1.

The cascode elements 9, 10 limit the voltage VQ across the current source 8 and take up some of the difference between the instantaneous VDC and the forward voltage of the active segments 6 of the LED array 4. The gate or base voltage VGC applied to the cascode elements 9, 10 determines the maximum voltage VC. It is advantageous for automatic threshold adaptation to keep this voltage low.

If the voltage VDC 2 increases starting from a value less than the forward voltage of the segment LED-S1 6, first the segment LED-S1 6 will begin to conduct current when the forward voltage is reached. If the current limited by the current source 8 has been reached and VQ has reached the value limited by the cascode element 9, 10, on a further increase in the VDC 2, the segment voltage VS1 increases, while VQ remains approximately constant.

First there is no current flowing through the segment LED-S2 6, and the segment voltage VS2 approximately corresponds to the voltage VQ. If VDC reaches the sum of the forward voltages of LED-S1 6 and LED-S2 6, LED-S2 6 also begins to conduct, and the current is divided between TC1 9 and TC2 10. The summation current is furthermore determined by the common current source 8 ILED. On a further increase in VDC 2, the voltage VS2 now increases in comparison with VQ. This increase indicates that LED-S2 6 is conducting, and the current path via TC1 9 can be disconnected. The disconnection can take place, for example, via an amplifier or comparator 11 AMP, whose comparison value is a settable magnitude above the voltage VQ. In order to avoid oscillations around the switching point, it is advantageous to provide a comparator 11 with a hysteresis. This applies in particular to the case where MOSFETs with a relatively high resistance are used as cascode elements 9, 10. When using bipolar transistors, the base current of said bipolar transistors needs to be limited.

Gradual disconnection, for example by means of an amplifier or a simple inverter with a gradual amplification in place of the comparator, is advantageous for avoiding possible noise emission owing to the switchover operations.

Takeover of the current by TC2 10 without switching of TC1 9 is likewise possible by virtue of a control voltage VG2>VG1 being applied, as illustrated in FIG. 4. When the segment LED-S2 6 becomes conducting, TC2 10 increases the voltage VQ and TCI 9 is automatically turned on. The voltage difference between VG2 14 and VG1 13 needs to be sufficiently high for TC1 9 to turn off safely, however, which is particularly important when integrating and using MOSFETs with a relatively high resistance.

In the case of a relatively large number “n” of LED segments, this can result in a considerable “scatter” of the controlling gate voltages VG1 to VGn. Therefore, the combination of graded actuation voltages with the disconnection of proceeding current paths is advantageous.

If the LED array 4 consists of more than two segments 6, the described procedure is repeated with a further increase in VDC 2 for the subsequent stages or current paths n+1, n+2 . . . etc. For the “last” segment 6 of the array 4, a cascode element 9, 10 is not absolutely necessary, but is advantageous in terms of circuitry for limiting the voltage VQ. This last cascode element 9, 10 does not need to be switched. FIG. 3 illustrates, by way of example, two cascode elements 9 and 10.

Once VDC 2 has exceeded its amplitude and there is a decrease in the voltage again, the cascode elements 9, 10 are activated again in the reverse order corresponding to the instantaneous voltage with the same circuitry.

FIG. 5 shows the voltage profiles during a half-period using the example of an LED array 4 consisting of four segments 6 with the same number of LEDs 5. In the illustration, no LED 5 is operated in the region around the zero crossing of the grid-side AC voltage 2 and there is no LED current flowing. Over the further course of time of a positive half-cycle, the voltage VDC 2 increases until the forward voltages of the LEDs 5 in the segment VLED-S1 6 is reached, current is flowing through the segment VLED-S1 6 and this segment 6 therefore illuminates. Over the further course of the positive half-cycle, the voltage VDC 2 continues to increase until the forward voltages of the LEDs 5 in the segments VLED S1 6 and VLED S2 6 are reached. After this time, current also flows through the segment VLED-S2 6, which now likewise illuminates.

This procedure is illustrated further until all segments 6 VLED-S1 to VLED-S4 have current flowing through them and illuminate. Once the maximum of the voltage VDC 2 has been reached, this voltage decreases sinusoidally, which results in the forward voltage of the segment VLED-S4 6 no longer being reached. This results in an interruption of the current flow in the segment VLED-S4 6 and therefore in disconnection thereof. Then, the segments VLED-S3 6, VLED-S2 6 and VLED-S1 6 are disconnected successively, as a result of which there is no longer a current flowing through the array 4.

The embodiment with identical segments 6 can be advantageous for the provision of an application, but is not a precondition for the functionality of the method. The voltage drop VQ across the current source 8 has not been included in the illustration for reasons of better understanding.

FIGS. 3, 4 and 6 show the constant current source 8 with a control input, via which the constant current can be controlled. Thus, the current profile of the constant current source can optionally be matched to the for example sinusoidal current profile of the rectified pulsating input voltage VDC by means of the input voltage VDC 2. This matching results in an improvement of the so-called power factor owing to the reduction of disruptive harmonics.

For operation of an LED luminaire using a dimmer, which operates by means of a phase-gating method (triac) or phase-chopping method (MOSFET or IGBT), a current path needs to be provided for charging a capacitor, which determines the current flow angle within a half-cycle of the mains voltage.

The previously described circuit 1 only conducts current when the forward voltage of the first LED segment 6 has been reached and only then can the time-determining capacitor be charged. Without further measures, therefore, the maximum current flow angle that can be achieved with a dimmer is reduced. In order to avoid this shortening, it is advantageous to design an additional current path which is already active when the mains voltage VDC is still lower than the forward voltage of the first segment 6, for example LED-S1.

This current is referred to as “bleeder current” since it is not used for actuating the LEDs 5 themselves. In FIG. 6, the circuit shown in FIG. 4 has been extended by a cascode or switching element TCBL 16 and a comparator or amplifier 15 AMPBL in accordance with the same principle. The bleeder current flows until VDC has exceeded the forward voltage of the segment LED-S1 6. In this case, the voltage VS1 increases and the comparator 15 AMPBL deactivates the bleeder path. While TCBL 16 is active, the current source ILED 8 provides the bleeder current.

The polarity of the described topology can be reversed, i.e. the current source 8 is then connected to the positive supply voltage (VDC) 2 and the cathode of the “lowermost” LED 5 is connected to the negative supply (GND). It is likewise easily possible for a high-side current source to be controlled by a ground-side or floating-potential current sensor.

### LIST OF REFERENCE SYMBOLS

1 LED actuation arrangement
2 Input
3 Outputs
4 LED array
5 LED
6 Segment
7 Connection/end
8 Constant current source
9 First electronic switch
10 Second electronic switch
11 First control unit
12 Second control unit
13 First reference voltage
14 Second reference voltage
15 Comparator/amplifier for “bleeder current”
16 Switching element TCBL

1. An arrangement for actuating light-emitting diodes, comprising an input, to which an AC input voltage can be applied, and an array of LEDs connected in series, wherein said array is connected to outputs of the arrangement and is divided into at least two segments, each segment of the array is connected at one end at least indirectly to a constant current source, a first connection of the input is connected to a first connection of a first segment of the array, a second connection of the first segment is connected to a first connection of a second segment of the array and to a first connection of a first electronic switch having a control input, a second connection of the switch is connected to a first connection of the constant current source, the constant current source is connected with a second connection to a ground potential and to a second connection of the input, a second connection of the second segment is connected to a first connection of a third segment of the array and to a first connection of a second electronic switch having a control input and to a first input of a first control unit, a second connection of the second electronic switch is connected to the first connection of the constant current source, a second input of the first control unit is connected to a first reference voltage, and an output of the first control unit is connected to a control input of the first electronic switch, a first input of a second control unit is connected to a second connection of the third segment, a second input of the second control unit is connected to a second reference voltage, and an output of the second control unit is connected to a control input of the second electronic switch.

2. An arrangement for actuating light-emitting diodes, comprising an input, to which an AC input voltage can be applied, and an array of LEDs connected in series, wherein the array is connected to outputs of the arrangement and is divided into at least two segments, each segment of the array is connected at one end at least indirectly to a constant current source, a first connection of the input is connected to a first connection of a first segment of the array, a second connection of the first segment is connected to a first connection of a second segment of the array and to a first connection of a first electronic switch having a control input, a second connection of the switch is connected to a first connection of a constant current source, the constant current source is connected with a second connection to a ground potential and to a second connection of the input, a second connection of the second segment is connected to a first connection of a second electronic switch having a control input, a second connection of the second electronic switch is connected to the first connection of the constant current source, a control input of the first electronic switch is connected to a first reference voltage and a control input of the second electronic switch is connected to a second reference voltage.

3. The arrangement as claimed in claim 1, wherein the first connection of the input is connected to a control input of the constant current source.

4. The arrangement as claimed in claim 1, wherein the first and/or second control unit is an amplifier or comparator.

5. The arrangement as claimed in claim 1, wherein the first and/or second electronic switch is a MOSFET, bipolar transistor or an IGBT.

6. A method for actuating light-emitting diodes, in which an array of light-emitting diodes connected in series is divided into segments, wherein each segment can contain a plurality of light-emitting diodes and has a first connection and a second connection, and wherein the array is operated on a rectified AC input voltage, comprising: applying the rectified AC input voltage to a first connection of a first segment of the array, and connecting second connections of all segments of the array to a means for generating a constant current via respective switching means, which results in a number n of stages which each comprise an n-th segment and an associated n-th switching means, wherein when an amplitude of the AC input voltage is zero volts, all of the switching means of all n stages are on, comparing an n-th reference voltage and a node voltage, measured at the second connection of a segment of the stage n+1, and if n-th reference voltage is lower than the node voltage, turning off the switching means of the n-th stage.

7. A method for actuating light-emitting diodes, in which an array of light-emitting diodes connected in series is is divided into segments, wherein each segment contains a plurality of light-emitting diodes and has a first connection and a second connection, and wherein the array is operated on a rectified AC input voltage, comprising: applying the rectified AC input voltage to a first connection of a first segment of the array, connecting second connections of all of the segments of the array to a means for generating a constant current via a respective switching means, which results in a number n of stages which each comprise an n-th segment and an associated n-th switching means, when an amplitude of the AC input voltage is zero volts, all of the switching means of all of the n stages are on, and if an amplitude of an n-th node voltage measured at the second connection of a segment of the stage n+1, is above a threshold value preset per stage, turning off the switching means of the stage n−1.

8. The method as claimed in claim 6, wherein the means for generating a constant current is controlled by amplitude of the AC input voltage.

9. The method as claimed in claim 6, further comprising: providing a current path in which a settable minimum current flow is generated when there is no current flowing through the segments of the array.

10. The method as claimed in claim 7, wherein the means for generating a constant current is controlled by amplitude of the AC input voltage.

11. The method as claimed in claim 7, further comprising: providing a current path in which a settable minimum current flow is generated when there is no current flowing through the segments of the array.

12. The method as claimed in claim 8, further comprising: providing a current path in which a settable minimum current flow is generated when there is no current flowing through the segments of the array.

13. The arrangement as claimed in claim 2, wherein the first connection of the input is connected to a control input of the constant current source.

14. The arrangement as claimed in claim 2, wherein the first and/or second electronic switch is a MOSFET, bipolar transistor or an IGBT.
